(19) United States
(12) Patent Application Publication
(10) Pub. No.: US 2011/0214545 A1
(43) Pub. Date: Sep. 8, 2011

(54) DEVICE FOR THE CUTTING OF FLEXIBLE, TWO-DIMENSIONAL PRODUCTS

(75) Inventors: Heinz Möckli, Grut (CH); Erwin Müller, Durnten (CH)

(73) Assignee: Ferag AG, Hinwil (CH)

(21) Appl. No.: 13/110,635

(22) Filed: May 18, 2011

Related U.S. Application Data
(63) Continuation of application No. 12/402,733, filed on Mar. 12, 2009.
Application No. 12/402,733 is a continuation of application No. 11/337,115, filed on Jan. 23, 2006.

(30) Foreign Application Priority Data
Jan. 21, 2005 (CH) 2005-0121

(51) Int. Cl. B26D 3/00; B26D 1/12

(52) U.S. Cl. 83/56; 83/673

(57) ABSTRACT

A device for cutting flexible, two-dimensional products. The device including a first and a second cutting means (5, 12), between which the two-dimensional products (2) may be cut essentially by way of an impulse cut. A method is also put forward for cutting by way of the impulse cut.

### CROSS REFERENCE TO RELATED APPLICATION(S)

This application is a continuation and claims the benefit of U.S. patent application Ser. No. 12/402,733, filed on 12 Mar. 2009, which is a continuation and claims the benefit of U.S. patent application Ser. No. 11/337,115, filed on 23 Jan. 2006.

### BACKGROUND OF THE INVENTION

1. Field of the Invention

The present invention originates from the field of the printing industry; it relates to a device and a method for cutting flexible, two-dimensional products, in particular printed products such as newspapers, magazines or parts thereof.

2. Description of Related Art

EP 762 950 discloses a device for handling printed products for carrying out an edge cut. This device is characterised essentially by the fact that a first conveyor loop with grippers is led running in the same direction as a second conveyor loop with clamping clips, and with this, a printed product held in a gripper is introduced into a clamping clip during a common movement path. Held in this clamping clip in a stabilising manner, the printed product is led to a cutting apparatus, wherein a positioning of the printed product is previously effected by way of releasing the gripper. The printed product is secured against undesired displacement during the cutting procedure by way of the clamping clip. This is required because the cutting apparatus during the cutting procedure exerts displacement forces onto the printed product and, without the clamping clip, an unclean cut would be effected as a result of this, The cutting apparatus comprises a knife and a counter-knife, wherein the counter-knife in the course of the common movement path may be applied onto a rear side of the free edge region projecting towards the cutting apparatus, and the knife engages at the front side thereof for carrying out the edge cut.

EP 673 729 also shows a means for cutting an edge of a printed product, wherein this is temporarily introduced into a pocket-like conveyor device and subsequently is led to a cutting device. The printed product in a conventional manner is held in the pocket-like conveyor device in a positioned manner, and is secured against displacement during the cutting procedure. Furthermore, a printed product edge to be cut is brought to bear on a shoulder of a support device by way of a counter bar directly before the engagement with the cutting knife. These holding measures serve for displacement-free cutting of edges of printed products.

A method for cutting two-dimensional material is known from CH 686 295, which is to effect an edge cut by way of a pure relative movement of a circular-saw-like knife with respect to the material to be cut. Thereby, whilst making do without a counter-knife, the material to be cut, is cut alone on account of the high rotational speed of the single knife carrier disk with a multitude of radially projecting knife blades as a result of the mass inertia and intrinsic stiffness of the material to be cut. Thereby, the material to be cut is supported alone by the holders distanced from the cutting edge. This solution may be adequate for lower quality edge cuts, but is not sufficient for good cutting qualities which are demanded today in the field of the further processing of printed products. Moreover with that design, the problem and the design effort of the transfer from conveyor means such as clips, to special cutting holders and the subsequent removal remain unsolved. Furthermore, that teaching limits the cutting forces depending on the properties of the material to be cut, since these must be smaller than the sum of the intrinsic stiffness and the mass inertia of the product to be cut.

Common to the previously outlined devices and methods for cutting printed products is that fact that not only is the machinery effort with regard to the cutting apparatus which are to be applied in each case, and to the conveyor devices for the processing stations “edge cutting” which this entails considerable, but also their control and regulation effort is accordingly extensive, and the previously mentioned disadvantages with the solution according to CH 686 295 remain.

Furthermore, the known cutting apparatus with their associated drives comprise numerous device elements, which with their intrinsic dynamics may caused fluctuations and vibrations in the whole conveyor path of printed products, and which are undesirable on account of their difficult controllability. At this stage, it is pointed out that each installed functional device element of a complete installation entails maintenance effort and overhaul expense, and furthermore influences the operational reliability and thus the “error-free operating hour number”.

### SUMMARY OF THE INVENTION

It is therefore the object of the present invention of develop a device and a method for cutting flexible, two-dimensional products, with a good cutting quality, to the extent that at least a part of the disadvantages of the cited state of the art is overcome. Thereby, not only is the device for cutting to be simplified with regard to the machinery effort, but its operational reliability is also to be increased.

The solution to the object on which the invention is based for the device and for the method are described and claimed herein below.

With regard to the device according to the invention, and the method according to the invention, for cutting flexible, two-dimensional products, these are cut by way of an impulse cut, wherein at least one knife part has a large impulse and cooperates with a second knife part for the cutting of the product. Added to this is the fact that with the inventive design of the cutting means, the products thereby may be processed by way of conventional conveyor means, in particular gripper transporters, pocket transporters or saddle transporters, without transfer to cutting holders. Thus existing installations may also be retrofitted with an impulse cutting device.

An impulse cut here is to be understood as the particular cutting of printed products with which a printed product, at the moment of cutting-off or knocking-off the edge regions to be separated, itself remains free of displacement forces, and thus the printed product experiences practically no acceleration since the cutting procedure is accomplished to all intents and purposes in an abrupt manner. The device for cutting thereby advantageously comprises a knife and a cutting edge, or a knife and a counter-knife, wherein the respective mass and the respective speed of the knife and of the cutting edge, or of the knife and of the counter-knife have a large impulse with respect to a product to be cut, which remains essentially unchanged on cutting.

One advantageous design of the invention envisages the knife and the cutting edge or the knife and the counter-knife being rotatably arranged about a rotation axis, wherein the knife and the cutting edge or the knife and the counter-knife rotate in opposite directions or in the same direction as one another with a respective speed. The angular setting of the knife and the counter-knife to one another is preferably selected, such that the two knife parts amongst one another enclose an angle and by way of this produce a shear effect. With this, in a preferred embodiment variant, the knife moved with a larger speed is moved parallel to the product to be cut, and the (stationary, slower co-running or counter-running) counter-knife is arranged obliquely to the product to be cut. With such a design, the bringing into contact of the counter-knife, or a suitable supporting of the product to be cut by way of the counter-knife or separate support elements, wherein this is accomplished usually prior to the actual cutting in conventional cutting means, is done away with. The synchronisation effort which is required at the same time, and the danger of a damage/impairment of the material to be cut, specifically when an additional clamping is provided with synchronously moved support elements is provided, may be done away with.

The impulse cutting device advantageously comprises a cage provided with a number of openings for the two-dimensional products, which is designed as a truncated cone, wherein at least one revolving knife revolves on a suitably smaller conical peripheral surface within the rotating cage, and the angle of inclination of the cone surface with respect to the rotation axis is selected, such that the speed difference from the outer radial edge to the radial inner edge of a product led past the impulse cutting device on an approximately circular path is compensated. A further advantageous embodiment of the invention envisages a cage provided with a number of openings for the two-dimensional products, which is rotatably arranged about a rotation axis and is designed in the shape of a cylinder, wherein at least one revolving knife revolves on a suitably smaller cylinder peripheral surface within the rotating cage.

Further advantageous designs of the invention envisage the first and/or second cutting means being arranged at an angle with respect to the edge of the two-dimensional product which is to be cut, or the first and/or second cutting means comprising a curved (geschwungen) contour with respect to the edge of the two-dimensional product, which is to be cut.

### BRIEF DESCRIPTION OF THE DRAWINGS

The invention is hereinafter described in more detail by way of examples represented in the drawings. Thereby, in a purely schematic manner there are shown in:

FIG. 1 an inventive impulse cutting device with cutting means, in a perspective representation and

FIG. 2 a plan view of the cutting means.

### DESCRIPTION OF THE INVENTION

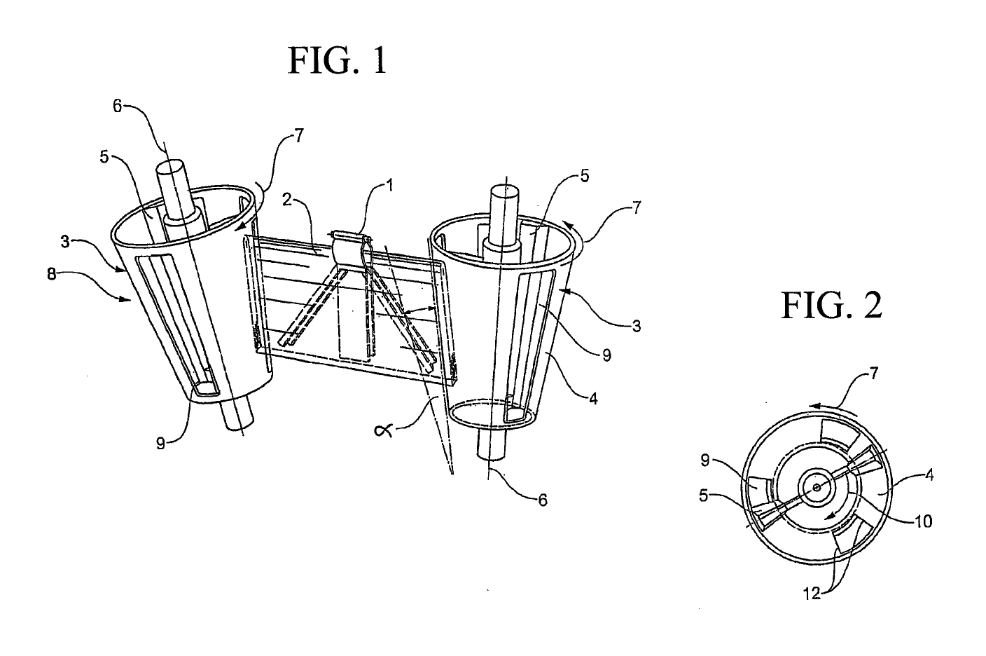

A cutting station 8 for cutting flexible, two-dimensional product 2, in particular printed products such as newspapers, magazines and likewise, is represented perspective in FIG. 1, wherein an impulse cutting device 3 is applied as a device according to the invention. The printed products 2 are led to the cutting station 8 with a number of grippers 1 (only one gripper is represented in FIG. 1). These grippers 1 may be of the conventional design type, e.g. according to EP 600183 or U.S. Pat. No. 5,369,151, wherein the printed products differently to the state of the art do not need to be additionally held or supported in a surfaced manner by way of cutting holders. The preferred gripper represented in FIG. 1 comprises an extension pointing away (here pointing downwards) from the gripped edge, and may be supplemented by two auxiliary arms which project in an angled manner. This extension or the two auxiliary arms, in contrast to two-dimensional pocket walls according to the state of the art, have no supporting effect with regard to the cutting function. Rather, with preferred embodiments they permit a spatial alignment of the printed sheets, and, as the case may be (here by way of the auxiliary arms), a stabilisation of the printed sheets from the travelling wind. What is essential is the fact that the edges of the printed product, which are to be cut, are not inhibited by these auxiliary means. The man skilled in the art recognises that alternative geometries and, as the case may be, adjustable auxiliary arms and likewise may effect the desired functions in a suitable manner. The transfer and removal of the printed products to cutting-holding means which is prone to breakdown may be done away with. In this manner, it is possible to supply the printed sheets on the most various of movement paths of the cutting station 8, and simultaneously (as explained further below in more detail) to bring the desired edge/edges into the cutting region of the impulse devices 3.

The impulse cutting device 3 is constructed in a rotationally symmetrical manner and comprises a cage 4 with openings 9 which rotates in a first direction 7 about the rotation axis 6. The openings 9 extend essentially in the longitudinal directions of the cage 4 and, at their long edges 12, as FIG. 2 shows, on the side facing the rotation axis 6, are preferably designed as knives or provided with exchangeable knives. Knives 5 likewise extending in the longitudinal direction of the cage 4 are provided in a second rotation direction 10 running opposite to the rotation direction 7.

The rotation of the cage 4 and the knife 5 is matched to the transport of the printed products 2, such that the edge of the printed product 2 which is to be cut, on reaching the impulse cutting device 3, meshes with an opening 9 of the cage 4, and here is chopped off by way of the counter-running of the knife 5 and of the long edge 12 of the cage opening 9, on account of the impulse acting on the edge. For this, the weight of the revolving knives 5 and of the cage 4 as well as further parameters such as those of their speed, design of the knife edges and the position of the knives 5 with respect to the cage opening 9, etc. are matched to parameters of the product to be cut, so as for example the thickness of the printed product 2 to be cut, the type of paper, the paper humidity and quality etc., in order to obtain the required cutting characteristics for an impulse cut. The design and arrangement of the impulse cutting device permits a very high impulse of the knives in comparison to the state of the art.

The position of the knives 5 to the long edges 12 of the openings 9 may be parallel or slightly oblique, so that a product to be cut between the knife 5 and the long edge 12 is knocked off either over the whole length simultaneously by way of the impulse (parallel position), or however continuously beginning at one end of the opening 9 up to the other end of the opening 9. The oblique position which defines the knife setting angle may not be selected too large here, so that the acting impulse is not too small. Without departing from the inventive concept, the long edge 12 of the cage opening 9 may also be arranged obliquely in the peripheral surface of the cage 4. Advantageously, as a further development, the rotating knives 5 as well as the long edges 12 may have a curved contour. Thus according to the invention, it is to be envisaged for the edge to be cut, to get into the region of the openings 9 of the cage 4, where the edges are cut by way of the impulse cut. As shown in FIG. 1, the invention advantageously permits the cutting of the products in a hanging position. The geometry of the cage furthermore permits an optimal suctioning of the cutting residue by way of suitable suction tubes (not shown).

An impulse cutting unit is for example provided as a cutting unit for cutting the edge lying opposite the gripper 1, and comprises a cage in the shape of a cylinder surface (not shown), and the knives rotating in the opposite direction within the cylinder surface are correspondingly arranged on a cylinder surface with a somewhat smaller radius. If the product 2 for the cutting of the side edges, the so-called head or foot cut, is led past an impulse cutting device 3 on an approximately circular path with a circular path axis, the cage 4, as shown in FIGS. 1 and 2, is preferably designed in the shape of a truncated cone. The knives 5 revolve on a corresponding, somewhat smaller cone peripheral surface. The angle of inclination a of the cone surface with respect to the rotation axis 6 at the same time is selected such that the speed difference from the radial outer edge to the radial inner edge of a printed product 2 led past the impulse cutting device 3 on an approximately circular path 2 is compensated. The impulse cutting device 3 thereby is arranged such that the cone peripheral surface is aligned radially to the circular path axis, about which the printed products 2 are led.

If the product 2 is led past an impulse cutting device 3 on a plane movement path, then the cage is preferably designed in a cylindrical manner and the knives run at the inside on a cylinder peripheral surface with suitably smaller radii.

The impulse cut is effected with the impulse cutting device according to the invention quasi in an abrupt manner, so that on the one hand the first and second cutting means being rotated undergo essentially no change of impulse on account of their mass and their rotational speed, and on the other hand the printed product to be cut experiences no displacement forces at the moment of cutting. Thus by way of this impulse cutting device, it becomes possible for the first time to eliminate the conventional cutting method step of “bringing into contact” a printed product directly before the cut. The printed product in a new manner is cut in an abrupt manner without having to be applied on a cutting edge or a counter-knife. Thus all device elements and their control and regulation devices which are applied with conventional cutting apparatus become superfluous.

It is also possible to arrange a truncated-cone-shaped impulse cutting device 3 in a region of a transporter with an essentially linear movement path of the product. For this, their rotation axes 6 are inclined with respect to the product to be cut or mutually, such that the cone peripheries run parallel to one another or parallel to the edges to be cut. The different peripheral speeds of the knives along the peripheral lines may furthermore be used for influencing the cutting forces. An adaptation to particular cutting geometries (for example slanted edge cuts) is likewise possible by way of adjusting the angular positing of the impulse cutting device 3.

With particular embodiments, the position of the edges to be cut may be supported by directed air nozzles before or during the cut. It is furthermore possible by way of grippers which may influence the pivot position of the product 2, to effect an alignment of the product with respect to the opening 9 (obliquely or parallel to the long edge 12).

The relative movement of the knives and counter knives may run in the same direction, with a desired speed difference, or as indicated by rotation directions 7 and 10, may be in opposite directions. A further possibility for influencing the edge cut lies in the mutual arrangement of the two long edges of an opening, wherein these preferably run at a slight angle to one another. The quality of the edge cut may furthermore be improved if the knives and counter knives are arranged obliquely against one another or have a curved course, so that the course of their mutual cutting angle with a continuous cutting along one edge has a non-linear course. Thereby, it is particularly envisaged for the cutting angle between the two cutting knives to reduce during the cutting.

Instead of a transport by way of grippers 1, as represented in FIG. 1, it is also possible to lead the products 2 to be cut past the impulse cutting device by way of a pocket transporter, or lying on saddles, and to cut their edges.

The impulse cutting method according to the invention is preferably applied when cutting printed products with a plurality of sheet pages of paper with a weight in the range of 42 to 60 g/m² which are to be cut. In a further advantageous embodiment, one cuts with only one knife, additionally to the embodiments with two knives, which are described in detail above. Thereby, at least one knife is arranged in a fixed or moving manner per impulse cutting device. With the known knife cut, the knife typically cooperates with a cutting bar or a counter-holder which is distanced by only a little. An as small as possible distance or cutting gap of approximately 0 μm would be ideal, irrespectively of whether the knife is moved with a vertical cut, with a vertical oblique cut or with a curved cut. Since in practise however, one needs to take account of factors such as the knife play, a distance on average of 10 to 15 μtm between the knife and counter-knife or counter-holder is indeed necessary in order to achieve a high quality of cut. This distance ensures that no contact between the knife and counter-holder or counter-knife occurs on cutting, despite the play of the knife. The distance therefore should under no circumstances be less than 0 μm, but on the other hand the knife play should permit maximally a distance of about 30 μm on cutting. The man skilled in the art assumes that a cutting engagement is no longer present with an average distance (in the idle condition) of significantly above 15 to above 30 μm, since the distance within the tolerance range may increase to far above 30 μm on account of the knife play. Accordingly, a high-quality knife cut in the conventional sense is only possible if the product to be cut is adequately supported at a distance between the knife and the counter-holder or counter-knife of below 15 to 30 μm.

Since with regard to the impulse cut according to the invention, the relative speed of the knife to the products to be cut is quite high compared to the conventional cutting methods, and the effective mass of the knife is also large, the support of the products to be cut becomes less significant, and the distance between the knife and counter-holder or counter-knife may be selected above 30 μm, without worsening the quality of the cut. This possibility of a distance of more than 30 μm (which for the previously mentioned cut paper products lies significantly above a conventional cutting gap according to the shear cut) is particularly advantageous, since in practise one may better counter the problems of the knife support as well as adjustment accuracies by way of this.

In the embodiment of the invention with a moved knife, the impulse p results from the product of the mass m of the knife and its speed v, wherein the impulse and the speed are vectors and thus have a direction. For this reason, the relative speed of the knife to the product to be cut is important for the impulse cut.

In preferred embodiments, a relative speed of above 20 m/s with distances of knife and counter-holder or counter-knife of above 30 μm have been successful. Thereby, the relative speed is either produced by way of a translation movement or a rotation movement of the knife, which in the cutting region runs in opposite directions or in the same direction to the conveyor movement of the product to be cut, or the knife is fixed and only the product to be cut is moved. Since the impulse is an extensive variable, the essential impulse of the knife according to the present invention is the sum of the impulses of the knife itself, the knife holder and further constituents of the device which form a common body with respect to the impulse.

With embodiments with rotating knives for cutting newspapers and magazines, this common body has a mass of 5 to 10 kg, wherein this is distributed in a symmetric manner. The mass may also be less than 5 kg with thinner products of up to 20 sheets.

The distance of the knife and counter-holder or counter-knife results from the size of the impulse. The higher the relative speed and the larger the mass, the larger may the distance be selected.

The embodiment of the device according to the invention shown in the FIGS. 1 and 2 is modified in a further embodiment in a manner such that the rotating knives 5 are replaced by a stationary knife. The long edge 12 of the cage opening 9 thereby is either designed as a counter-knife or as a counter-holder.

In further embodiments of the present invention which are not represented in the Figures, the knives are not arranged in the inside of the cage, but on its outer side. With regard to this, it has been shown to be advantageous to design the knives in the region of the cutting edge in a very thin manner and/or to arrange the cutting edge on the side distant to the cage, in order not to unnecessarily hinder the transport movement of the products to be cut. The mass of the knife providing the impulse is preferably arranged outside the cutting region.

1. A device for cutting flexible-products, wherein the device is designed as an impulse cutting device with which a cutting unit comprises a first cutting device moving parallel to a second cutting device with a distance of greater than 30 μm between the first cutting device and the second cutting device, wherein between the first cutting device and the second cutting device the products are cut by an impulse cut.

2. A device according to claim 1, wherein the first cutting device comprises a rotating knife having a mass of 5 kg to 10 kg.

3. A device according to claim 14, wherein the rotating knife rotates at a speed of at least 20 m/s.

4. A device according to claim 1, wherein the first cutting device comprises a knife and the second cutting device comprises a cutting edge, wherein a mass and a speed of each of the knife and the cutting edge, with respect to the products to be cut, provide an impulse which remains essentially unchanged by the cutting of the products.

5. A device according to claim 4, wherein the first cutting device comprises a rotating knife having a mass of 5 kg to 10 kg and that rotates at a speed of at least 20 m/s.

6. A device according to claim 1, wherein the first cutting device comprises a knife and the second cutting device comprises a counter-knife, wherein a mass and a speed of each of the knife and the counter-knife, with respect to the products to be cut, provide an impulse which remains essentially unchanged during the cutting of the products.

7. A device according to claim 6, wherein the first cutting device comprises a rotating knife having a mass of 5 kg to 10 kg and that rotates at a speed of at least 20 m/s.

8. A device according to claim 1, wherein the first cutting device and the second cutting device are rotatably arranged about a rotation axis, wherein the first and the second cutting devices are arranged on the cutting unit running in opposite directions or in the same direction, in each case with a rotation speed.

9. A device according to claim 1, wherein the second cutting device comprises a cage provided with a number of openings for the two-dimensional products, and which is rotatably arranged about a rotation axis, wherein within or outside the rotating cage, the first cutting device comprises at least one revolving knife arranged revolving over a correspondingly smaller or larger periphal surface, or is rigidly arranged.

10. A device according to claim 9, wherein the cage is designed in the shape of a truncated cone, wherein at least one revolving knife revolves over a corresponding cone peripheral surface within or outside the rotating cage.

11. A device according to claim 10, wherein an inclination angle (a) of the cone surface with respect to the rotation axis is selected, such that the speed difference from the radial outer edge to the radial inner edge of a product led past the impulse cutting device on an approximately circular path, is compensated.

12. A device according to claim 10, wherein the first cutting device has a curved contour with respect to an edge of the two-dimensional product which is to be cut.

13. A device according to claim 10, wherein the cutting devices are arranged to one another such that their mutual cutting angle has a non-linear course.

14. A device according to claim 1, wherein the second cutting device comprises a cage which is provided with a number of openings for the two-dimensional products and which is rotatably arranged about a rotation axis and is designed in the shape of a cylinder, wherein at least one revolving knife revolves within the rotating cage over a correspondingly smaller cylinder peripheral surface.

15. A device according to claim 14, wherein the number of openings is arranged obliquely in the periphal surface of the cage with respect to an edge of the two-dimensional product which is to be cut.

16. A device according to claim 14, wherein the number of openings has a curved opening contour in the peripheral surface of the cage, with respect to an edge of the two-dimensional product which is to be cut.

17. A device according to claim 16, wherein the first cutting device is arranged obliquely with respect to an edge of the two-dimensional product which is to be cut.

18. A device according to claim 1, wherein the cutting gap ensures no contact between the rotating first cutting device and the second cutting device.

19. A method for cutting flexible, two-dimensional products, comprising cutting the two-dimensional products by way of an impulse cut by a cutting unit according to claim 1.

20. A device for cutting flexible products, comprising an impulse cutting device including a rotating first cutting device which rotates with respect to a second cutting device, the rotating first cutting device rotating at a distance from the second cutting device of greater than 30 μm to ensure no contact between the rotating first cutting device and the second cutting device, wherein the products are cut by an impulse cut between the rotating first cutting device and the second cutting device.
